(19) United States
(12) Patent Application Publication
(10) Pub. No.: US 2016/0265964 A1
(43) Pub. Date: Sep. 15, 2016

(54) DRAFT SHIELD FOR A PRECISION BALANCE AND SUSPENSION GUIDE FOR A SIDE PANEL OF A DRAFT SHIELD

(71) Applicant: Sartorius Lab Instruments GmbH & Co. KG, Goettingen (DE)

(72) Inventors: Otto KUHLMANN, Goettingen (DE); Michael LAUBSTEIN, Goettingen (DE); Jan VON STEUBEN, Goettingen (DE)

(21) Appl. No.: 15/164,274

(22) Filed: May 25, 2016

Related U.S. Application Data
(63) Continuation of application No. PCT/EP2014/002812, filed on Oct. 18, 2014.

(30) Foreign Application Priority Data
Nov. 25, 2013 (DE) 102013113006.2

(51) Int. Cl. G01G 21/28

(52) U.S. Cl. CPC G01G 21/286

(57) ABSTRACT

A draft shield for a precision balance surrounding a weighing chamber (16), with a side panel (26) and a suspension guide (78) for the side panel. The suspension guide has a guide rail (38) and a holding device (84) for the side panel that is displaceably mounted in the guide rail. The holding device has a seating (86) for the side panel and a guide element (92) which engages in the guide rail and is displaceably mounted therein, wherein the side panel is held with an upper edge (76) in the holding device. The guide element is arranged outside a plane (E) defined by the side panel seating; the holding device is mounted in the guide rail pivotable about a contact line (96) between the guide element and the guide rail. The plane (E) is offset outwardly relative to the guide rail in relation to the weighing chamber.

### CROSS REFERENCE TO RELATED APPLICATIONS

This is a Continuation of International Application PCT/EP2014/002812, which has an international filing date of Oct. 18, 2014, and the disclosure of which is incorporated in its entirety into the present Continuation by reference. The following disclosure is also based on and claims the benefit of and priority under 35 U.S.C. §119(a) to German Patent Application No. DE 10 2013 113 006.2, filed Nov. 25, 2013, which is also incorporated in its entirety into the present Continuation by reference.

### FIELD OF THE INVENTION

The invention relates to a draft shield for a precision balance, which surrounds a weighing chamber, having at least one side panel and a suspension guide for the side panel, wherein the suspension guide comprises a guide rail and a holding device for the side panel, wherein the holding device is displaceably mounted in the guide rail, wherein the holding device has a seating for the side panel and at least one guide element which engages in the guide rail and is displaceably mounted therein, wherein the side panel is held with an upper edge in the holding device of the suspension guide. The invention also relates to a suspension guide for a side panel of such a draft shield.

### BACKGROUND

It is commonly known to mount a draft shield on a precision balance, said draft shield surrounding a space above the weighing dish of the balance. Examples of a draft shield of this type are disclosed by DE 94 07 984 U1 and EP 1 195 585 A1. The draft shield has the task of preventing air movements, electrostatic attractive forces or thermal radiation from influencing the weighing process. In order to be able to place an object to be weighed on the weighing dish, a draft shield of this type has a side panel which can be displaced between a closed position and an open position.

A further draft shield is disclosed in EP 2 251 657 A1. This has guidance means, for example, guide rails for the side panel in which the side panel is mounted such that it is pressed with the lower edge against the bottom of the draft shield. However, the side panels must be exactly oriented before being suspended in the guidance means.

From U.S. Pat. No. 3,975,862, sliding doors are known which are mounted such that they support one another and, despite the lack of floor-side guide rails, remain in the vertical position and do not snag one another.

In order to clean the draft shield or to gain unhindered access to the weighing dish, it is desirable to be able to demount this panel completely, preferably without the use of tools. At the same time, in the closed position, the side panel must close the weighing chamber completely so that the effects of environmental influences on the weighing process are reliably prevented.

### SUMMARY

It is an object of the invention to provide a suspension guide for a side panel of a draft shield of a precision balance which enables simple demounting and mounting of the side panel, but also enables reliable guidance and tight closing of the side panel. It is a further object of the invention to provide a draft shield for a precision balance which is demountable easily and without tools and which ensures reliable sealing of the weighing chamber.

In order to achieve these objects, according to one formulation of the invention, a draft shield of the type mentioned in the introduction is provided, in which the guide element is arranged outside a plane which is defined by the seating of the side panel and in which the holding device is mounted in the guide rail pivotable about a contact line between the guide element and the guide rail, wherein the plane of the side panel in relation to the weighing chamber is arranged offset outwardly relative to the guide rail.

The side panel of the draft shield can be fastened in the seating of the holding device, wherein the side panel is arranged in the plane defined by the seating. Since the guide element is arranged outside the plane defined by the seating and the side panel, the guide element is situated laterally offset relative to the side panel. Thus the guide element is arranged outside the center of gravity of an assembly consisting of the holding device and the side panel. When this assembly is hooked into the guide rail in which it is mounted displaceable in the longitudinal direction, this assembly has the tendency to tilt inwardly about the contact line of the guide element on the guide rail until the center of gravity is situated below the contact line.

Preferably provided on the draft shield or on the precision balance is a contact surface against which the lower edge of the side panel comes into contact or is pressed due to this tilting tendency. The contact surface is preferably configured such that the side panel makes contact areally with the lower edge so that the lower edge is tightly closed by the contact of the side panel against the contact surface. Therefore, due to the contact surface, which preferably extends parallel to the guide rail, a tight closure at the lower edge of the side panel is possible without additional guides or sealing elements being required. The sealing takes place automatically due to gravity, by which the lower edge is pressed against the contact surface.

Since the contact surface preferably extends in the direction of the guide rail, the contact surface can also serve as a guide for the side panel in order to guide the lower edge of the side panel between the open and closed positions. An arrangement of a further guide rail at the lower edge of the side panel is not necessary. A planar contact surface on which the side panel can make contact is thus entirely sufficient as a guide and also for tight contact.

Since the assembly of the side panel and the holding device only makes contact at the lower edge of the draft shield with the contact surface and is not held by the lower edge, easy demounting of the side panel is also possible. For this purpose, the side panel must only be unhooked from the suspension guide arranged at the upper edge, for example, in that it is lifted upwardly out of the guide rail. The mounting of the side panel is also substantially facilitated since it is only required to hook the holding device into the guide rail. Additional mounting or threading of the lower edge of the side panel into a lower guide is not necessary. Due to the tilting tendency, the side panel comes automatically into contact with the contact surface so that orientation of the lower edge of the side panel is not necessary.

Through this arrangement of the guide elements, it is thus ensured that they are arranged outside the center of gravity of the assembly of holding device and side panel, so that after hooking into the guide rail, this assembly has a tendency to tilt against a contact surface. Preferably, a contact surface is provided on the draft shield, against which the lower edge of the side panel can lie, wherein the contact surface is arranged parallel to the plane of the side panel. Preferably, the contact surface is arranged such that the plane of the side panel in the mounted state of the side panel extends substantially vertically. The contact surface serves both as a stop for the side panel, in order to seal the lower edge of the side panel, and also as a guide surface along which the side panel can slide in order to displace it between the closed position and the open position.

The stop surface is arranged, for example, offset in relation to a vertical through the guide rail in the direction toward the side panel, so that the side panel is pressed against the stop surface by gravity. Thus, a pressing force of the side panel against the contact surface is ensured, by which a reliable sealing of the lower edge of the side panel is ensured.

Even when the side panel is pressed against the contact surface due to the center of gravity being offset relative to the contact line, a guide projection which holds the lower edge of the side panel against the contact surface can additionally be provided.

Preferably, the draft shield has a cover which closes the weighing chamber upwardly. The guide rails can be provided, for example, on the cover. The cover can, for example, also be constructed multi-part so that, for example, the cover element is formed by a part of the cover.

In order to prevent influencing of the measurement result by electrostatic charging of the draft shield, the side panel and/or the suspension guide are configured to be electrically conductive and/or coated and are electrically coupled to one another so that electrostatic charges can be conducted away.

According to a further formulation of the invention, a suspension guide for a side panel of a draft shield is provided, having a guide rail and a holding device for the side panel, displaceably mounted in the guide rail, wherein the holding device has a seating for the side panel and at least one guide element which engages in the guide rail and is displaceably mounted therein. According to this formulation, the guide element is arranged outside a plane which is defined by the seating of the side panel and the holding device is mounted in the guide rail pivotable about the contact line between the guide element and the guide rail.

In order to enable easy mounting and demounting of the side panel, the guide rail has, for example, an upwardly open groove into which the at least one guide element can easily be hooked in from above. The holding device with the side panel can thus easily be removed upwardly from the guide rail. Therefore, easy demounting is possible without the need for additional tools. At the same time, secure guidance of the holding device and thus of the side panel is ensured, since the guide elements cannot tilt laterally out of the guide rail.

The guide elements of the holding device can be, for example, rollers which roll along on the guide rail. With the rollers, a lower resistance is possible during displacement of the side panel or the holding device between the open position and the closed position. In addition, due to the form of the rollers, a very narrow contact line, about which the holding device can tilt, is possible. With suitable bearings for the rollers, for example ball bearings, the rolling resistance can be further reduced.

For demounting the side panel, the holding device can preferably be removed upwardly out of the guide rail. In order to prevent unintentional demounting of the side panel, for example, a cover element which covers the guide rail is provided. This cover element is configured such that it covers the guide rail and the guide element in a holding position so that the guide element cannot be removed from the guide rail. Only when the cover element has been removed or moved into a releasing position in which the guide rail is no longer covered can the guide element be removed from the guide rail.

### BRIEF DESCRIPTION OF THE DRAWINGS

Further advantages and features are disclosed in the following description making reference to the accompanying drawings. In the drawings:

FIG. 1 is a perspective view of a balance with a draft shield according to the invention,

FIG. 2 is the balance of FIG. 1 with the side panels in the open position and the front panel removed,

FIG. 3 is a perspective view of the balance of FIG. 1 with the cover partially open,

FIG. 4 is the draft shield of FIG. 3 from a second perspective,

FIG. 5 is a perspective view of a support frame of a cover of the draft shield of FIG. 1 with guide rails of a suspension guide according to the invention,

FIG. 6 is a perspective view from below of a cover element for a suspension guide according to the invention,

FIG. 7 is a side view of the balance of FIG. 1, in a partial sectional view in the region of the suspension guide and the cover,

FIG. 7A is a partial view of the balance of FIG. 7, in the region of the suspension guide and the cover,

FIG. 8 is a perspective view of a side panel of the balance of FIG. 1 with a holding device of a suspension guide according to the invention,

FIG. 9 is the holding device of FIG. 8 in a detail view,

FIG. 10 is the holding device of FIG. 8 in a detail view,

FIG. 11 is a sectional view through the holding device of FIG. 8 in the region of a guide element,

FIG. 12 is a sectional view through the draft shield of the balance of FIG. 1 in the region of the side panel,

FIG. 13 is a detail view of the contact surface of the draft shield of the balance of FIG. 1,

FIG. 14 is the balance of FIG. 1 with the cover element removed,

FIG. 15 is a perspective view of the weighing chamber bottom of the precision balance of FIG. 1,

FIG. 16 is a rear view of the weighing chamber bottom of FIG. 15,

FIG. 17 is the precision balance of FIG. 1 with the weighing chamber bottom partially demounted, and

FIG. 18 is a second view of the precision balance of FIG. 17 with the front panel removed.

### DETAILED DESCRIPTION

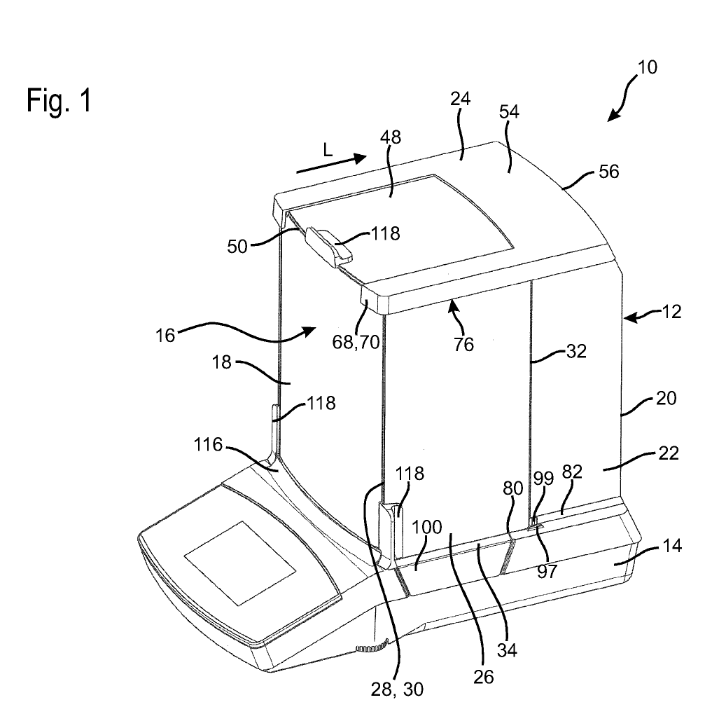

FIG. 1 shows a precision balance 10 with a weighing device 14 and a draft shield 12. The draft shield 12 serves to surround a weighing chamber 16 above the weighing device 14 and thus to protect the weighing dish of the weighing device 14 against external influences, for example, air movements, electrostatic attractive forces or thermal radiation and thereby to ensure an accurate measurement.

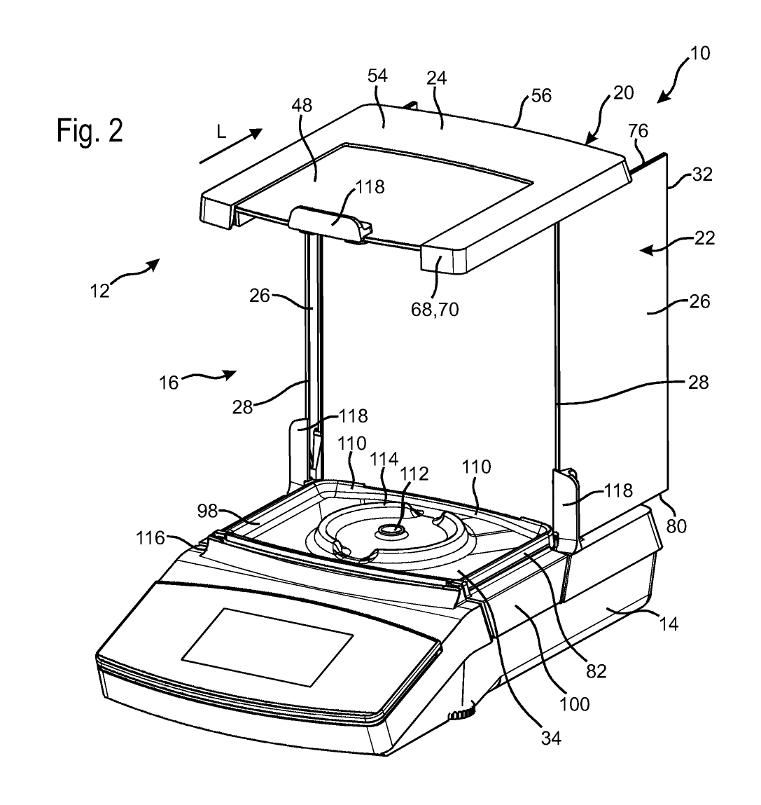

The draft shield 12 has a front panel 18, a rear wall 20 and two mutually opposed side walls 22. In addition, a cover 24 is provided which closes the draft shield 12 upwardly. The rear wall 20 is firmly connected to the weighing device 14 and forms a support for the cover 24. The side walls 22 each have a side panel 26 which are respectively displaceable between a closed and an open position (FIG. 2). The side panel 26 and the front panel 18 extend from the cover 24 to the weighing device 14.

In the closed position shown in FIG. 1, the front edges 28 of the side panels 26 lie against the side edges 30 of the front panel 18. The rear edges 32 of the side panels 26 lie against the side walls 22. The side walls 22 are tightly connected to the rear wall 20. Since the side panels 26 and the front panel 18 are also closed off upwardly at the cover 24 and downwardly at the weighing device 14, the weighing chamber 16 is completely self-contained in the closed position of the side panels 26.

In order to be able to clean the draft shield 12 and the precision balance 10 easily, the side panels 26, the front panel 18, parts of the cover 24 and the weighing chamber bottom 34 are configured demountable, as will now be described. In particular, all the parts can be demounted without tools.

The demountable components of the draft shield 12 and the precision balance 10 will now be described.

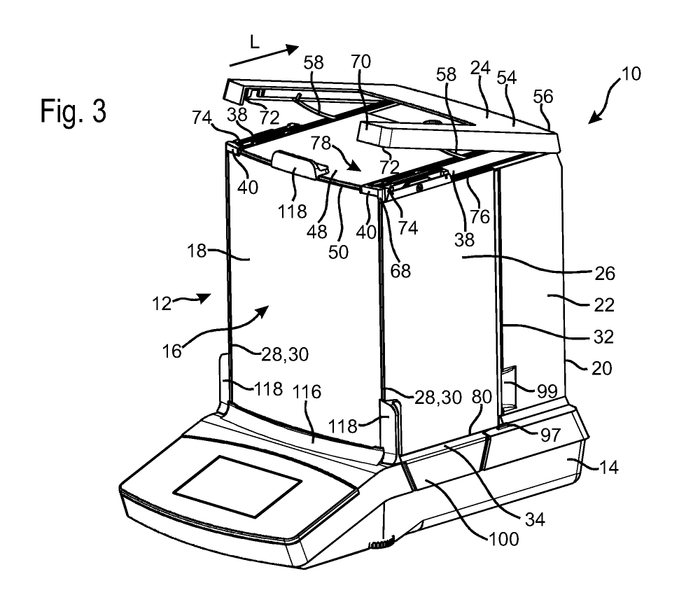

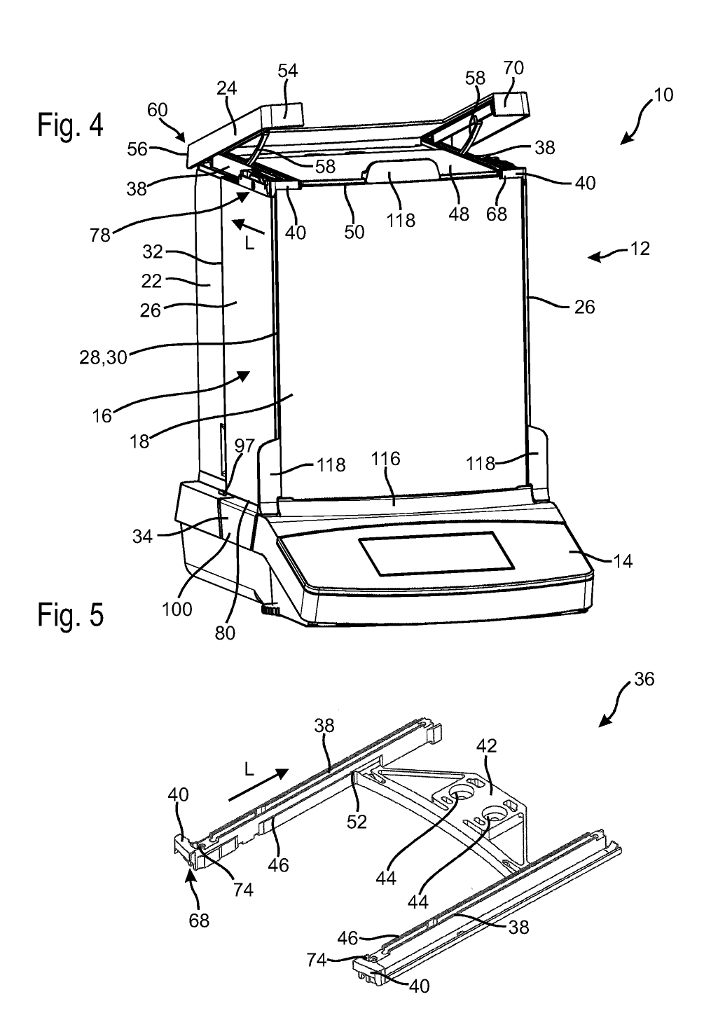

As shown in FIGS. 3 and 4, the cover 24 of the draft shield 12 has a support frame 36 which is held at the rear wall 20. Guide rails 38 for the side panels 26 and holding elements 40 for the front panel 18 are provided on this support frame.

As shown in FIG. 5, the holding elements 40 are provided at a front end of the guide rails 38. The two guide rails 38 are connected to one another with a holding geometry 42. Provided on this holding geometry 42 are fastening apertures 44 for mounting the support frame 36 on the rear wall 20.

Additionally, provided on the surfaces of the guide rails 38 facing one another are slide rails 46 extending in the longitudinal direction L of the guide rails 38. A cover panel 48 (see FIGS. 3 and 4) is mounted on these slide rails 46 and makes contact, in a closed position, with the upper edge 50 of the front panel 18. In order to provide access to the weighing chamber 16, the cover panel 48 can be displaced in the longitudinal direction L on the slide rails 46.

The slide rails 46 are made preferably of plastics. The remainder of the support frame 36 can be made of metal, for example aluminum, or also of plastics. The cover panel 48 is made, for example, of glass and preferably has an electrically conductive coating. The fact that the slide rails 46 are made of plastics reliably prevents scratching of the cover panel 48. In order to prevent electrostatic charging of the cover panel 48, electrical conductors 52, for example carbon brushes, are provided in the rear region of the slide rails 46 on the support frame 36, wherein the brushes lie against the cover panel 48 and connect the cover panel electrically to the support frame 36.

In order to prevent electrostatic charging of the cover 24, all the parts of the cover 24 can either be configured electrically conductive or coated so that electric charges can be conducted away.

Similarly, the front panel 18, the side panels 22 and all the further parts of the draft shield 12 or the precision balance 10 can be configured electrically conductive and/or coated and electrically connected to one another so that electrostatic charging of individual parts, in particular the panel, is reliably prevented.

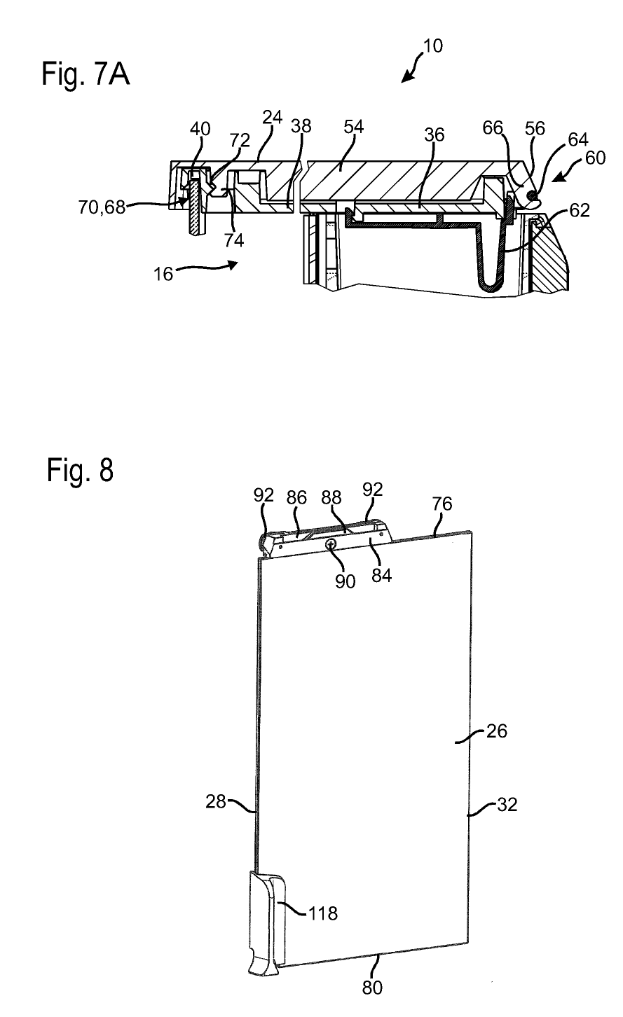

The cover 24 also has a cover element 54 which, as described below, is pivotable at one edge 56 of the cover 24, here the rear edge 56, between a holding position (FIG. 1) and a releasing position (FIGS. 3 and 4). Provided between the support frame 36 and the cover element 54 are spring elements 58 which load the cover element 54 toward the releasing position. The bearing 60 of the cover element 54 on the support frame 36 is formed by bearing elements 62 provided on the support frame 36, each comprising a bearing pin 64 (see FIGS. 7 and 7A). The bearing elements 62 are configured to be resilient in the longitudinal direction L. Bearing hooks 66 which are open in the longitudinal direction L, that is, rearwardly, and can engage on the bearing pins 64 are provided on the cover element 54.

Since the bearing elements 62 are configured resilient in the longitudinal direction L, the whole cover element 54 can be displaced to a limited extent in the direction toward the bearing 60, wherein the cover element is loaded by the elastically yielding bearing elements 62 in the direction toward a second edge 68, here the front edge 68 of the support frame 36.

In order to hold the cover 24 in the closed holding position (FIG. 7), holding elements 72, 74 are provided at the front edge 70 of the cover element opposite the bearing 60 and at the front edge 68 of the support frame. The holding elements 72, 74 are configured such that they fix the cover element 54 at the front edge 68 of the support frame 36. By displacement of the cover element 54 in the longitudinal direction L in the direction toward the bearing 60, the holding elements 72, 74 can be released.

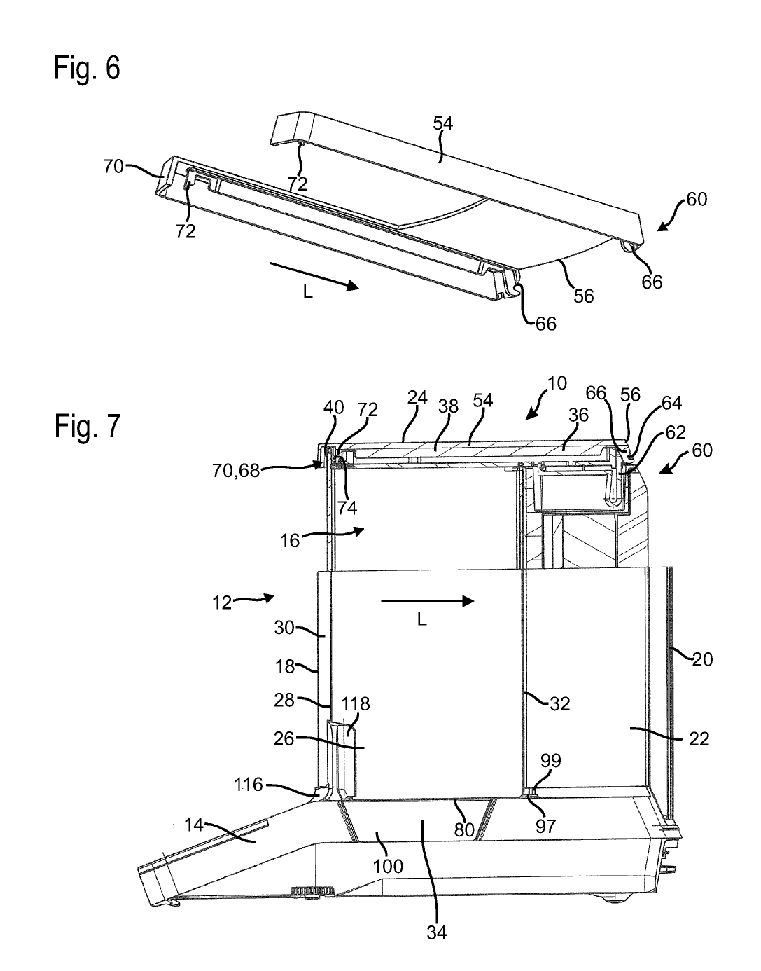

As shown in FIG. 6, the holding elements 74 are formed on the cover element 54 by locking elements facing away from the bearing hooks 66. The holding elements 72 provided on the support frame 36 are formed by locking receptacles which are directed in the direction toward the bearing 60. If the locking hooks, that is, the holding elements 74 are moved in the direction toward the bearing 60, they are released by the holding elements 72 formed by the locking receptacles, so that the cover element 54 can be pivoted about the bearing 60 into the releasing position.

The holding elements 72, 74 are thus released, for example, by a pressure on the front edge of the cover element 54, by which the cover element is displaced toward the bearing 60. Subsequently, the cover element 54 is moved by the spring elements 58 into the releasing position.

Even if no spring elements 58 are provided, it is easily possible to release the holding elements 72, 74 and to move the cover element into the releasing position. In order to release the holding elements 72, 74, pressure on the front edge 70 is needed. Following the release of the holding elements, the pressing direction must merely be changed and directed slightly upwardly. In the preferred embodiment, it is possible to select a pressing direction facing obliquely upwardly and in the longitudinal direction L, by which sufficient pressing force is applied to release the holding elements 72, 74 and the cover element 54 is subsequently moved into the releasing position without any change in the pressing direction. Thus, the cover element can be moved in a fluid movement from the holding position into the releasing position. Elaborate releasing of the holding elements 72, 74 is not necessary.

In the releasing position shown in FIGS. 3 and 4, it is also possible to remove the cover panel 48 from the support frame 36 without tools in that the cover panel is removed upwardly out of the slide rails 46.

Furthermore, in this releasing position, as described below, the side panels 26 of the draft shield 12 can also be removed without tools.

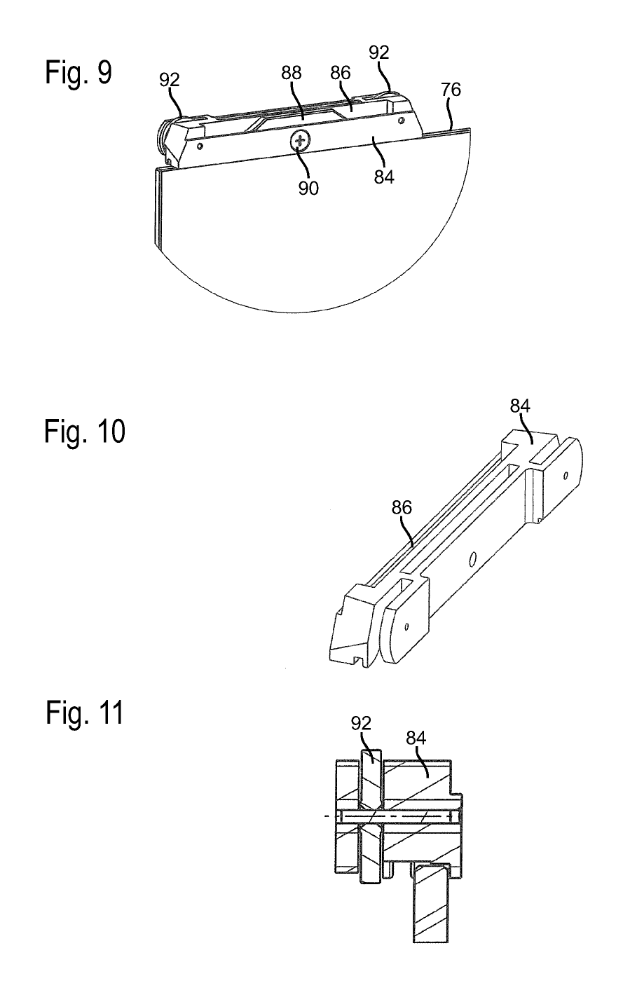

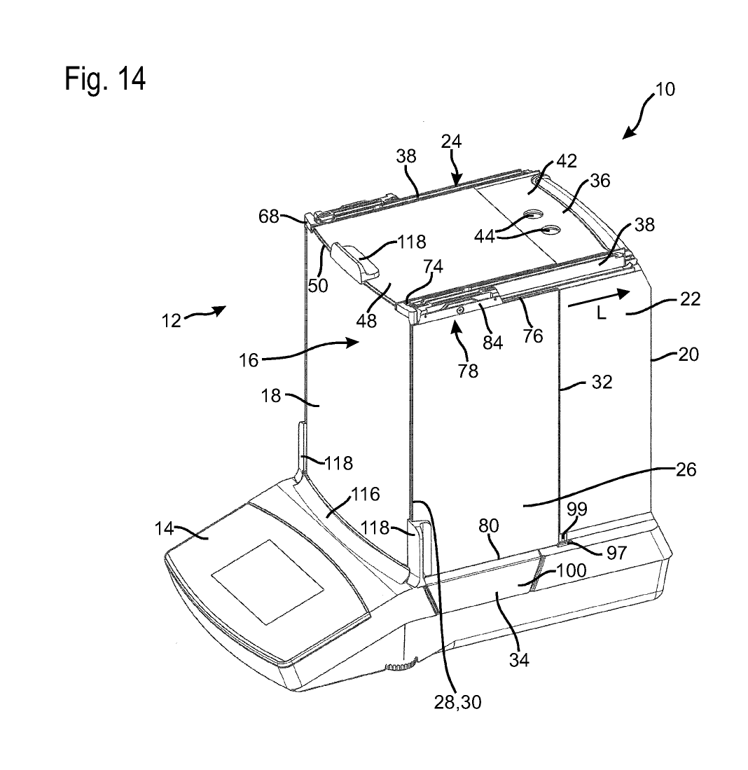

As shown in FIG. 14, the cover element 54 can also be completely removed after moving into the releasing position, so that easier removal of the cover panel 48 and the side panels 26 is possible. This removal is possible since the bearing hooks 66 are configured open so that they can be easily released from the bearing pins 64. In the holding position, however, the bearing hooks 66 are biased by the spring pre-tension of the bearing elements 62 against the bearing pins 64 so that release is not possible. The bearing hooks 66 can, for example, also latch onto the bearing pins 64 in order to provide additional security against removal of the cover element 54. The mounting of the side panels 26 is achieved with a suspension guide 78, shown in detail in FIGS. 8 to 12, arranged at the upper edge 76 of the side panels 26 and a contact surface 82 provided at the lower edge 80 of the side panels 26.

The suspension guides 78 are each formed by a guide rail 38 of the support frame 36 and by a holding device 84 on which the side panel 26 is held.

As shown in FIGS. 8 to 11, the holding device 84 has a seating 86 for the side panel 26. The seating 86 is formed by a slot through which a projection 88 of the side panel 26 is fed (FIG. 8). The projection 88 is fixed at the seating 86 by a screw 90. The screw 90 can clamp the side panel against the seating 86 or can extend through the side panel.

Also provided on the holding device 84 are guide elements 92 formed by rollers, with which the holding device 84 can be mounted in the guide rails 38 displaceable in the longitudinal direction L.

The contact surface 82 is formed by a lateral border of the weighing chamber bottom 34, wherein the contact surface 82 extends in the longitudinal direction L and substantially vertically.

The guide rails 38 each have an upwardly open groove 94 into which the guide elements 92 can be hooked in vertically from above. The assembly made of the holding device 84 and the side panel 26 can be pivoted in this assembled state about the contact line 96 between the guide rails 38 and the guide elements 92.

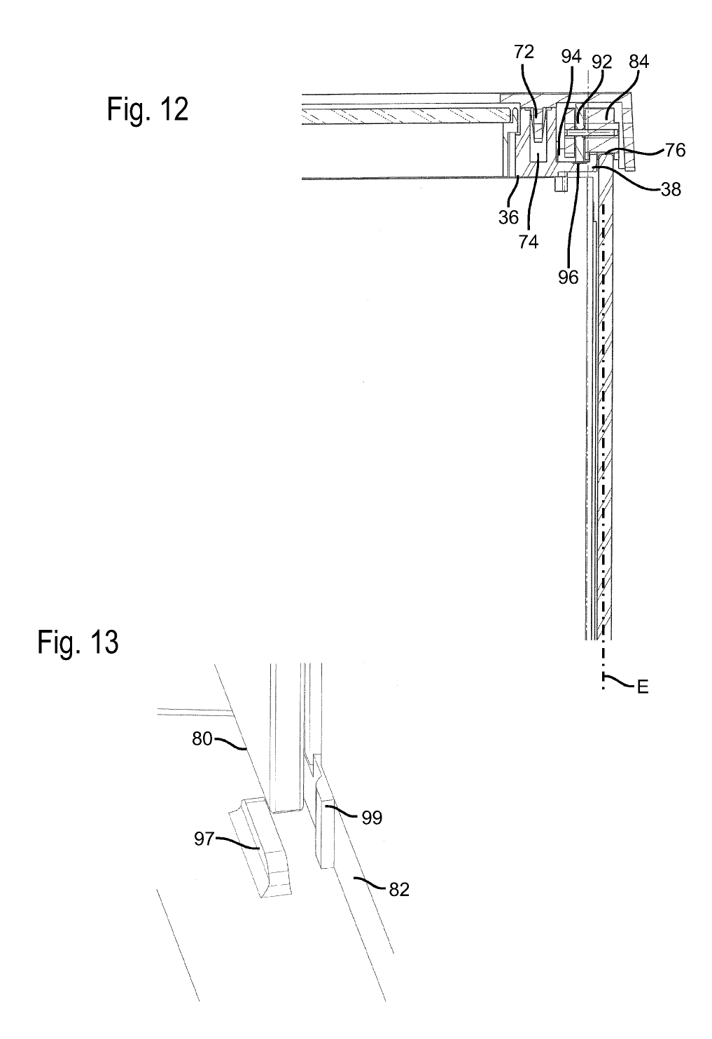

As shown particularly in FIG. 12, the guide elements 92 are arranged outside the plane E which is formed by the seating 86 and the side panel 26. In this way, the center of gravity of the assembly formed from the holding device 84 and the side panel 26 is situated, in relation to FIG. 12, laterally offset relative to the vertical through the contact line 96. By reason of gravity, this assembly is therefore urged to move the center of gravity under the contact line 96. As a result, the side panel 26 is pressed with the lower edge 80 against the contact surface 82 so that the side panel 26 makes close contact with the contact surface 82.

Since the contact surface 82 extends in the longitudinal direction L, it also serves as a guide for the lower edge 80 of the side panel 26. Also provided on the contact surface 82 is a guide projection 97, which serves as a protective device in order to prevent lifting of the lower edge 80 of the side panel 26 from the contact surface 82. In normal operation of the precision balance 10 or of the draft shield 12, however, this guide projection 97 is not needed since the side panel 26 is pressed by gravity against the contact surface 82. Furthermore, a detent stop 99 is provided on the side surface 22 which holds the side panel 26 in the closed position.

Apart from the suspension guide 78 arranged at the upper edge 76 of the side panels 26, therefore, no additional complex mounting is needed at the lower edge 80.

Since the guide rails 38 are formed by upwardly open grooves 94, the side panels 26 can be easily removed vertically upwardly from the guide rails 38.

The mounting of the side panels 26 is also simplified since they have merely to be hooked into the guide rails 38 with the holding devices 84 or the guide elements 92. Due to gravity, the lower edges 80 automatically come into contact with the contact surfaces 82. Complex orientation of the lower edges 80 or feeding into a lower guide is not necessary.

In order to prevent the removal of the side panels 26 during normal operation of the draft shield 12, in the holding position, the cover element 54 covers the guide rails 38 vertically upwardly. The guide elements 92 thus cannot be removed from the guide rails. In order to be able to remove the side panels 26, it is necessary to move the cover element 54 into the releasing position in which the guide rails 38 are open vertically upwardly.

Irrespective of the configuration of the holding device or of the guide elements 92, it is merely necessary for the guide elements 92 to be arranged outside the plane formed by the side panel 26 or the seatings 86, so that the side panel can tilt about the contact line 96 between the guide rail 38 and the guide element 92 against the contact surface 82.

In order to prevent tilting in the plane of the side panels 26, a plurality of holding devices 84 can also be provided at a side panel 26.

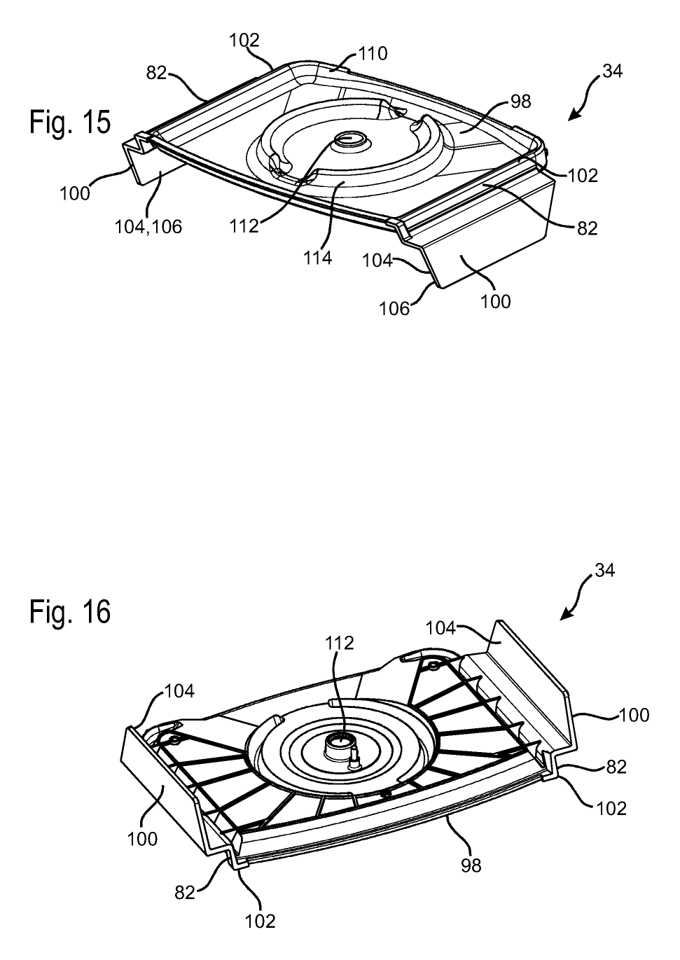

As shown in FIGS. 15 to 18, the contact surfaces 82 are arranged on the weighing chamber bottom 34 of the precision balance 10. Apart from the cover 24, the side panels 26 and the front panel 18, the weighing chamber bottom 34 is also configured demountable, so that it can also be removed from the precision balance 10 for cleaning.

For this purpose, the weighing chamber bottom 34 has a weighing chamber bottom portion 98 and two side flanges 100. The side flanges 100 are disposed at opposing edges 102 of the weighing chamber bottom portion 98 and are arranged substantially perpendicular to the weighing chamber bottom portion 98 and parallel to one another.

Situated at the inner surfaces 104 facing one another are fastening devices 106 which in this embodiment are formed by locking elements. Provided on the housing of the weighing device 14 are substantially horizontally extending locking edges 108 on which the fastening devices 106 can engage.

The weighing chamber bottom 34 is placed vertically from above onto the weighing device 14, wherein the side flanges 100 encompass the housing on opposite sides. The weighing chamber bottom 34 is pushed onto the housing until the fastening devices 106 latch onto the locking edges 108. The side flanges 100 are configured elastically resilient so that they can give way during pushing onto the locking edges. If the fastening devices 106 are located behind the locking edges, the side flanges 100 are pressed resiliently against the housing, so that the fastening devices 106 latch onto the locking edges 108.

For demounting of the weighing chamber bottom 34, the side flanges 100 are pulled away laterally until the fastening devices 106 are released from the locking edges 108. Subsequently, the weighing chamber bottom 34 can be pulled upwardly from the housing (FIG. 18).

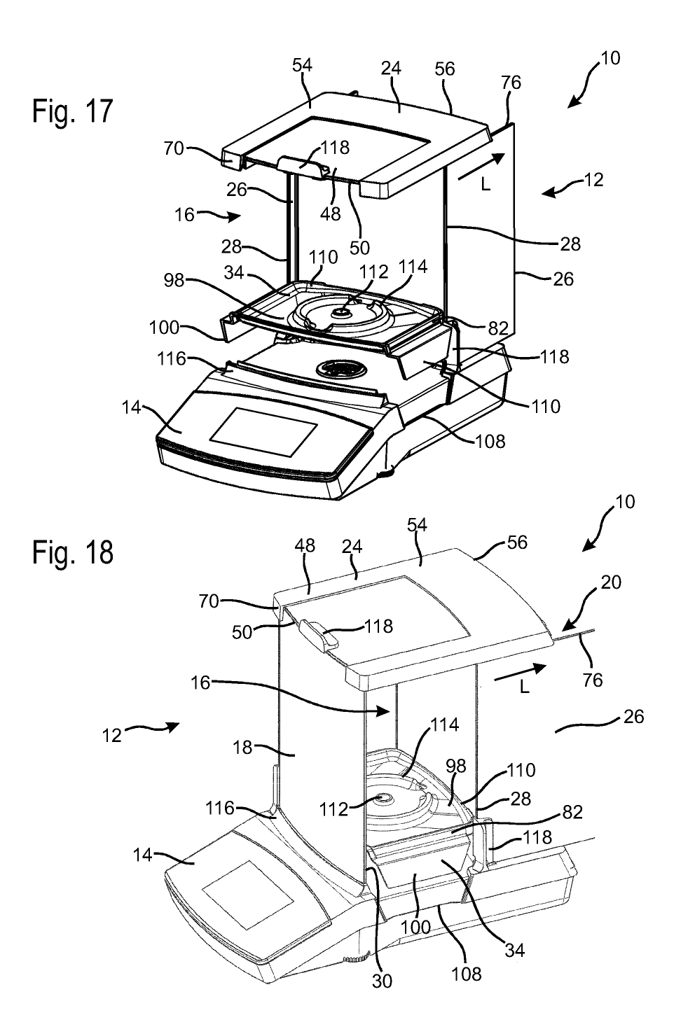

As shown in FIGS. 15 and 17, the contact surfaces 82 for the side panels 26 are each formed by a shoulder provided on the side flanges 100, on which the guide projection 97 is also provided. Depending on the form of the housing and of the weighing chamber bottom 34, however, a shoulder of this type is not necessary.

The weighing chamber bottom portion 98 is configured essentially planar (FIG. 15) wherein the peripheral edges 110 are raised relative to the remaining weighing chamber bottom portion 98. Situated centrally is a through opening 112 for a weighing mechanism (not shown in detail). Formed around this through opening 112 is also a raised edge 114.

The raised edges 110, 114 prevent liquids that find their way onto the weighing chamber bottom portion 98 from flowing out of the weighing chamber bottom 34 and flowing, for example, through the through opening 112 to the weighing mechanism and contaminating it.

As shown in FIGS. 16 and 17, the side flanges 100 of the weighing chamber bottom 34 form the side walls 22 of the draft shield 12 in places. Since therefore no gap is present between the side walls and the weighing chamber bottom portion 98, liquids or foreign bodies which find their way onto the weighing chamber bottom 34 cannot penetrate into the housing and contaminate the weighing mechanism.

As FIGS. 17 and 18 show, apart from the side panels 26, the cover 24 and the weighing chamber bottom 34, the front panel 18 can also be removed from the holding elements 40 and a holding rail 116. For this purpose, the holding elements 40 are configured resilient to a limited extent in the vertical direction so that for removal of the front panel 18, they can be lifted upwardly.

Thus, approximately all the parts of the draft shield 12 can be demounted without tools, so that easy cleaning of the draft shield 12 and the precision balance 10 and easy access to the weighing chamber 16 are possible.

In order to be able to clean the panels easily, that is, the cover panel 48, the side panel 26 and the front panel 18, components present on the panels, for example, handles 118 or the holding devices 84 can also be easily demounted, preferably without tools. In particular, the handles 118 can be easily latched on the panels, wherein tool-free release of this latching is possible.

What is claimed is:

1. A draft shield for a precision balance, which surrounds a weighing chamber, comprising:
at least one side panel and
a suspension guide for the side panel, wherein the suspension guide comprises a guide rail and a holding device for the side panel,
wherein the holding device is displaceably mounted in the guide rail,
wherein the holding device has a seating for the side panel and at least one guide element which engages in the guide rail and is displaceably mounted therein,
wherein the side panel is held with an upper edge in the holding device of the suspension guide,
wherein the guide element is arranged outside a plane which is defined by the seating of the side panel,
wherein the holding device is mounted in the guide rail pivotable about a contact line between the guide element and the guide rail, and
wherein the plane of the side panel is arranged offset from the guide rail in an outward direction with respect to the weighing chamber.

2. The draft shield as claimed in claim 1, further comprising a contact surface, against which a lower edge of the side panel is configured to lie, wherein the contact surface is arranged parallel to the plane of the side panel.

3. The draft shield as claimed in claim 2, wherein the contact surface is arranged offset from a vertical that extends through the guide rail in a direction toward the side panel, so that the side panel is pressed against the contact surface by gravity.

4. The draft shield as claimed in claim 2, further comprising a guide projection on the contact surface which holds the lower edge of the side panel against the contact surface.

5. The draft shield as claimed in claim 2, further comprising a cover, wherein the guide rail is provided on the cover.

6. The draft shield as claimed in claim 1, wherein the side panel and/or the suspension guide is/are configured or coated to be electrically conductive and/or are electrically conductively connected to one another.

7. A suspension guide for a side panel of a draft shield as claimed in claim 1, comprising:
a guide rail and a holding device for the side panel,
wherein the holding device is displaceably mounted in the guide rail,
wherein the holding device has a seating for the side panel and at least one guide element which engages in the guide rail and is displaceably mounted therein,
wherein the guide element is arranged outside a plane which is defined by the seating of the side panel, and
wherein the holding device is mounted in the guide rail pivotable about the contact line between the guide element and the guide rail.

8. The suspension guide as claimed in claim 7, wherein the guide rail has an upwardly open groove into which the at least one guide element is hooked in from above.

9. The suspension guide as claimed in claim 7, wherein the guide elements comprise rollers which roll along the guide rail.

10. The suspension guide as claimed in claim 7, further comprising a cover element which covers the guide rails.
